(19) United States
(12) Patent Application Publication
(10) Pub. No.: US 2026/0211479 A1
(43) Pub. Date: Jul. 23, 2026

(54) SIGNAL MANAGEMENT SYSTEM AND PROJECTOR

(71) Applicant: Coretronic Corporation, Hsin-Chu (TW)

(72) Inventors: Pin-Jou Lu, Hsin-Chu (TW); Yun-Tzai Liao, Hsin-Chu (TW); Sheng-Han Yang, Hsin-Chu (TW)

(73) Assignee: Coretronic Corporation, Hsin-Chu (TW)

(21) Appl. No.: 19/454,427

(22) Filed: Jan. 21, 2026

(30) Foreign Application Priority Data
Jan. 22, 2025 (CN) 202510099223.6

(51) Int. Cl. G06F 1/3234

(52) U.S. Cl. CPC G06F 1/3234

(57) ABSTRACT

A signal management system includes a signal input/output module and a control unit. When the control unit determines that the signal conversion unit of the signal input/output module is in an idle state, the signal input/output module is controlled to be operated in a low power mode; otherwise, the signal input/output module is controlled to be operated in a normal working mode. A first power consumption value of the signal conversion unit in the low power mode is less than a second power consumption value in the normal working mode, thereby improving the problem of continuous electrical energy consumption by the signal conversion unit in the idle state, and enhancing energy utilization efficiency. A projector including the signal management system is also provided.

### CROSS-REFERENCE TO RELATED APPLICATION

This application claims the priority benefit of China application serial no. 202510099223.6, filed on Jan. 22, 2025. The entirety of the above-mentioned patent application is hereby incorporated by reference herein and made a part of this specification.

### BACKGROUND

### Technical Field

This disclosure relates to a signal management system and a projector, and particularly relates to a signal management system and a projector possessing such signal management system.

### Description of Related Art

In general, electronic devices such as projectors possess signal input/output modules for connecting external devices to receive external signals or provide signals. The signal input/output modules mainly include ports for connecting signal cables or wireless communication, and signal processors for processing input/output signals. However, when a port of one of the signal input/output modules is not in use, but the signal processor corresponding to that port is still operating, it may lead to electrical energy waste in the electronic device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In view of the poor energy use efficiency of modules for inputting/outputting signals in existing electronic devices, this disclosure provides a signal management system and a projector to improve energy use efficiency.

The signal management system of this disclosure includes at least one signal input/output module and a control unit. The at least one signal input/output module is electrically connected to the control unit, and is configured to be controlled by the control unit to operate in one of a normal working mode and a low power mode. The at least one signal input/output module includes a connection port, a power supply unit, and a signal conversion unit. The connection port is configured to receive an original input signal. The signal conversion unit is electrically connected to the connection port, and is configured to receive the original input signal from the connection port. The power supply unit is electrically connected to the signal conversion unit, and is configured to provide electrical energy to the signal conversion unit. When the at least one signal input/output module is operated in the normal working mode, the connection port is configured to receive the original input signal, the power supply unit provides the electrical energy to the signal conversion unit, so as to enable the signal conversion unit to conduct format conversion on the original input signal from the connection port, to generate a target format signal. When the control unit determines that the signal conversion unit is in an idle state, the control unit controls the at least one signal input/output module, making the at least one signal input/output module to be operated in the low power mode. The signal conversion unit in the low power mode corresponds to possessing a first power consumption value, the signal conversion unit in the normal working mode corresponds to possessing a second power consumption value, the first power consumption value is less than the second power consumption value.

The projector of this disclosure includes a signal management system, an image processing unit, a light source module, a light modulation module, and a projection lens. The signal management system includes at least one signal input/output module and a control unit. The at least one signal input/output module is electrically connected to the control unit, and is configured to be controlled by the control unit to operate in one of a normal working mode and a low power mode. The at least one signal input/output module includes a connection port, a power supply unit, and a signal conversion unit. The connection port is configured to receive an original input signal. The signal conversion unit is electrically connected to the connection port, and is configured to receive the original input signal from the connection port. The power supply unit is electrically connected to the signal conversion unit, and is configured to provide electrical energy to the signal conversion unit. When the at least one signal input/output module is operated in the normal working mode, the connection port is configured to receive the original input signal, the power supply unit provides the electrical energy to the signal conversion unit, so as to enable the signal conversion unit to conduct format conversion on the original input signal from the connection port, to generate a target format signal. When the control unit determines that the signal conversion unit is in an idle state, the control unit controls the at least one signal input/output module, making the at least one signal input/output module to be operated in the low power mode. The signal conversion unit in the low power mode corresponds to possessing a first power consumption value, the signal conversion unit in the normal working mode corresponds to possessing a second power consumption value, the first power consumption value is less than the second power consumption value. The image processing unit is electrically connected to the signal conversion unit to receive the target format signal, and the image processing unit is configured to perform image processing on the target format signal to provide a processed target format signal. The light source module is configured to provide an illumination light beam. The light modulation module is electrically connected to the image processing unit, and is disposed on a transmission path of the illumination light beam, and is configured to convert the illumination light beam into an image light beam based on the processed target format signal provided by the image processing unit. The projection lens is disposed on a transmission path of the image light beam, and is configured to project the image light beam outside the projector

Based on the above, the signal management system and the projector of this disclosure may automatically or passively reduce the power consumption of the signal conversion unit or stop providing power to the signal conversion unit according to the actual usage or usage requirements of the signal conversion unit. As a result, the signal management system and the projector possessing the signal management system effectively save electrical energy without affecting usage, better utilize energy and avoid waste of electrical energy.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a block diagram of a signal management system of this disclosure.

FIG. 1B is a block diagram of another signal management system of this disclosure.

FIG. 1C is a block diagram of yet another signal management system of this disclosure.

FIG. 2A is a flowchart of the operation of the signal management system of this disclosure.

FIG. 2B is a flowchart of the operation of a first embodiment of the signal management system of this disclosure.

FIG. 2C is a flowchart of the operation of a second embodiment of the signal management system of this disclosure.

FIG. 2D is a flowchart of the operation of a third embodiment of the signal management system of this disclosure.

FIG. 2E is a flowchart of the operation of a fourth embodiment of the signal management system of this disclosure.

FIG. 3A is a block diagram of a projector of this disclosure.

FIG. 3B is a block diagram of partial components of still another signal management system of this disclosure.

FIG. 4A is a menu screen of an active power-saving function presented by a user interface of the projector of this disclosure.

FIG. 4B is a menu screen of a power-saving operation status setting function presented by the user interface of this disclosure.

FIG. 4C is a diagram showing the proportion of accumulated usage time of different connection ports compared to the total usage time of this disclosure.

### DESCRIPTION OF THE EMBODIMENTS

It is to be understood that other embodiment may be utilized and structural changes may be made without departing from the scope of this disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The following description refers to embodiments of this disclosure shown in the accompanying drawings to assist readers in fully understanding the methods, devices and/or systems described herein. Therefore, for those skilled in the art, various changes, modifications, or equivalent substitutions may be suggested to the system, device, and/or method described herein. Additionally, for clarity and conciseness, descriptions of well-known functions and structures may be omitted. Furthermore, where possible, the same reference numerals are used in the drawings and description to refer to the same or similar parts.

Some projectors may incorporate a power-saving mode to conserve electrical energy. For example, a common practice is for the projector to enter a power-saving mode when no input source is detected for a period of time. In the power-saving mode, the projector may reduce or turn off the light source until it detects an input signal again, at which point the projector's brightness will be restored to its original setting. However, generally speaking, when the projector is in sleep mode, idle integrated circuits (ICs) continue to operate, thereby generating a certain amount of power consumption.

Additionally, projectors typically have multiple input/output (IO) terminals for receiving input signals from external devices. It is worth noting that even when the projector is in a working status, some of the input/output terminals may be idle, but the signal conversion ICs for these idle input/output terminals continue to operate. In other words, these signal conversion ICs still consume power.

In this disclosure, the control unit may reduce the power consumption of the signal conversion ICs or stop providing power to the signal conversion ICs based on their actual usage. As a result, the power-saving effect of the projector may be improved.

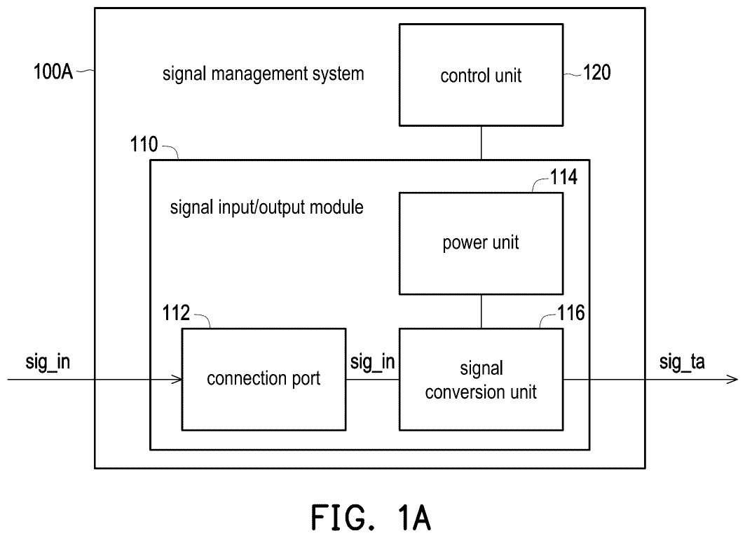

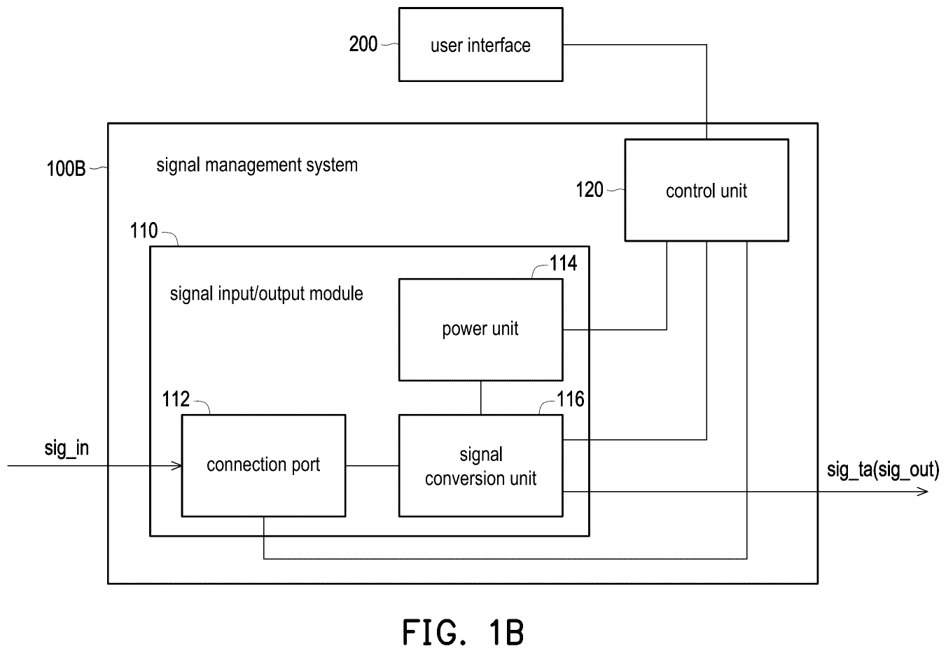

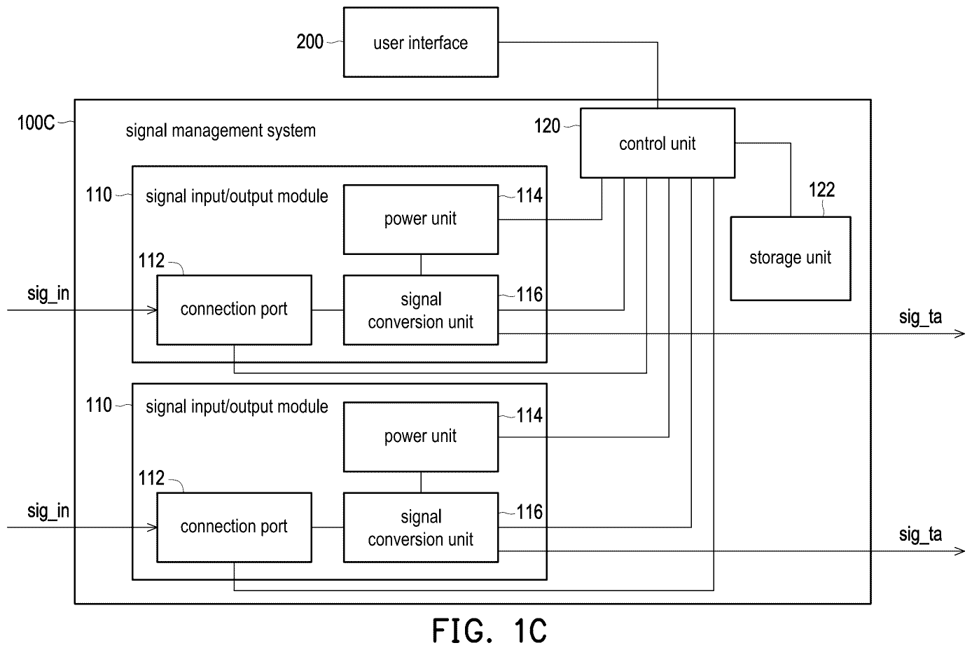

FIG. 1A to FIG. 1C respectively illustrate different embodiments of signal management systems 100A, 100B, 100C of this disclosure.

First, please refer to FIG. 1A. The signal management system 100A of this disclosure includes at least one signal input/output module 110 and a control unit 120. FIG. 1A illustrates an example with one signal input/output module 110. The signal input/output (I/O) module 110 is electrically connected to the control unit 120, and the signal input/output module 110 includes at least one connection port 112, a power unit 114, and at least one signal conversion unit 116. The connection port 112 is used to connect to an external device to receive an original input signal sig_in. The signal conversion unit 116 is electrically connected to the connection port 112 to receive the original input signal sig_in from the connection port 112. The power unit 114 is electrically connected to the signal conversion unit 116 to provide electrical energy to the signal conversion unit 116. The signal input/output module 110 is controlled by the control unit 120 to operate in either a normal working mode or a low power mode.

More specifically, please refer to FIG. 1B. In some embodiments, the control unit 120 is separately coupled to the connection port 112, the power unit 114, and the signal conversion unit 116 of the signal input/output module 110, thereby receiving signals from or transmitting control signals to the connection port 112, the power unit 114, and the signal conversion unit 116 respectively. In some embodiments, the signal management system 100A may be configured in an electronic device (not shown). The electronic device includes a user interface 200, and the control unit 120 is also electrically connected to the user interface 200 to present relevant information to the user or receive operation signals from the user.

Please refer to FIG. 1C. In some embodiments, the signal management system 100C includes multiple signal input/output modules 110, a control unit 120, and a storage unit 122. Each of the multiple signal input/output modules 110 includes a connection port 112, a power unit 114, and a signal conversion unit 116, and the control unit 120 of the signal management system 100C is separately coupled to each signal input/output module 110 and the storage unit 122. In some embodiments, the control unit 120 is separately coupled to the connection port 112, the power unit 114, and the signal conversion unit 116 in each signal input/output module 110.

As shown in FIG. 1C, the storage unit 122 is built into the control unit 120. The storage unit 122 may include a combination of one or more static or dynamic random access memories (RAM), read-only memories (ROM), flash memories, hard drives, or any other similar devices. In other embodiments, the storage unit 122 may not be configured within the signal management system 100C, but may be an external component coupled to the control unit 120.

Please refer again to FIG. 1A to FIG. 1C. When the control unit 120 controls the signal input/output module 110 to operate in the normal working mode, the connection port 112 may receive an original input signal sig_in from an external device, and the power unit 114 provides electrical energy to the signal conversion unit 116, enabling the signal conversion unit 116 to perform format conversion on the original input signal from the connection port 112 to generate a target format signal sig_ta. The target format signal sig_ta may be, for example, an input signal in the target format required by the back-end circuit of the electronic device where the signal management systems 100A to 100C is located. Alternatively, the target format signal sig_ta may also be an output signal provided to another connection port (not shown in the figure).

When the signal conversion unit 116 is not receiving an original input signal or not performing format conversion work, it is in an idle state.

When the control unit 120 determines that the signal conversion unit 116 is in an idle state, the control unit 120 may control the signal input/output module 110 to operate in a low power mode. When the control unit 120 controls the signal input/output module 110 to operate in the low power mode, the signal input/output module 110 reduces its own power consumption value (i.e., having a lower power consumption value). For example, the signal conversion unit 116 of the signal input/output module 110 may has a first power consumption value in the low power mode correspondingly, while the signal conversion unit 116 of the signal input/output module 110 may has a second power consumption value in the normal working mode correspondingly, and the first power consumption value is less than the second power consumption value.

The specific implementation methods for operating the signal input/output module 110 in the low power mode are explained as follows.

In some embodiments, the control unit 120 may send a power-saving instruction to the signal conversion unit 116, conducting the signal conversion unit 116 to enter a power-saving state, thereby operating the signal input/output module 110 in the low power mode. The power-saving state of the signal conversion unit 116 may include at least one of the following methods: reducing the working frequency, turning off specific circuit blocks (for example, audio-related circuit blocks), or disabling specific functions, thus controlling the signal input/output module 110 to operate in the low power mode.

In some other embodiments, the control unit 120 may be electrically connected to the power unit 114. The control unit 120 may control the power unit 114 to not provide electrical energy to the signal conversion unit 116, thereby operating the signal input/output module 110 in the low power mode. Specifically, the control unit 120 is electrically connected to the enable pin of the power unit 114. When the signal input/output module 110 is operated in the normal working mode, the control unit 120 outputs a high voltage signal to the Enable pin of the power unit 114 to enable the power unit 114, and the power unit 114 normally provides electrical energy to the signal conversion unit 116, with the signal conversion unit 116 possessing the second power consumption value. When the signal input/output module 110 is operated in the low power mode, the control unit 120 outputs a low voltage signal to the Enable pin of the power unit 114 to disable the power unit 114, and the power unit 114 does not provide electrical energy to the signal conversion unit 116. The signal conversion unit 116 has no electrical energy input and thus stops working, and the first power consumption value of the signal conversion unit 116 is 0 at the time.

In one embodiment, the control unit 120 may include a central processing unit (CPU), or other programmable general-purpose or special-purpose MCU, microprocessor, digital signal processor (DSP), programmable controller, application specific integrated circuit (ASIC), graphics processing unit (GPU), input signal processor (ISP), arithmetic logic unit (ALU), complex programmable logic device (CPLD), field programmable gate array (FPGA), or other similar components or combinations of the above components. However, this disclosure is not limited to this.

In one embodiment, the connection port 112 may include a High-Definition Multimedia Interface (HDMI) input port, DisplayPort (DP), Serial Digital Interface (SDI) input port, Serial Digital Interface output port, High-Definition Base Transmission (HDBaseT) port, combinations of the above components, or other similar components.

The signal conversion unit 116 is used to receive input signals provided by the input port 112 or the previous stage circuit, and perform format conversion on the received input signals to generate converted signals with a format acceptable to the next stage circuit. Moreover, the signal conversion unit 116 may be implemented using appropriate hardware components, and this disclosure does not impose any limitations on this.

The power unit 114 may be, for example, one or a combination of a Buck Converter, Buck-boost Converter, LLC Converter, or any power supply device capable of providing suitable working electrical energy for the signal conversion unit 116. In some embodiments, each signal input/output module 110 may possess its own independent power unit 114. In other embodiments, the power units 114 of at least two signal input/output modules 110 may be integrated into a single power supply device. In such condition, the multiple output terminals of the integrated power supply device connected to each signal conversion unit 116 must be isolated from each other.

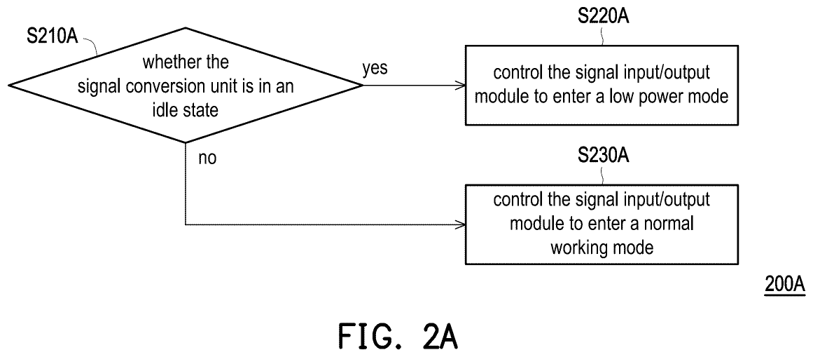

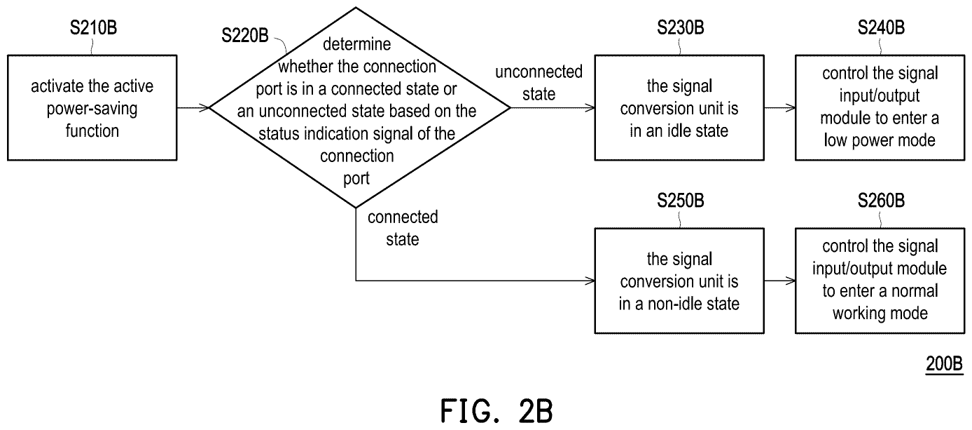

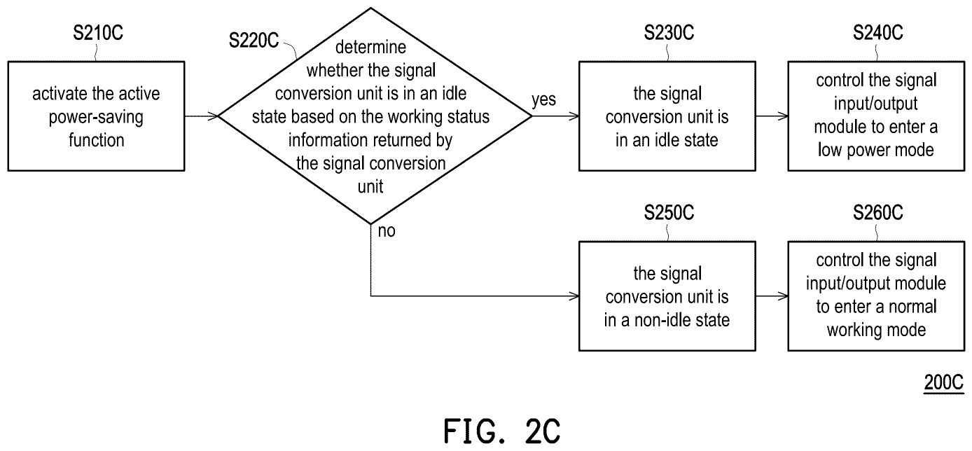

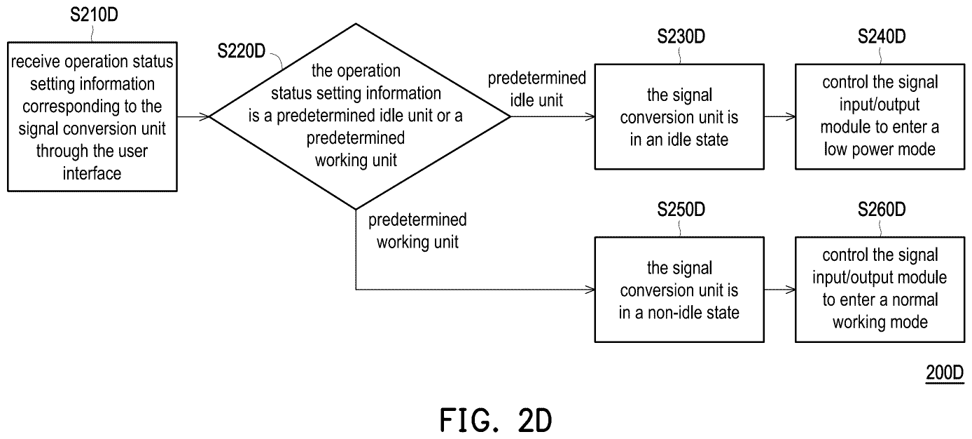

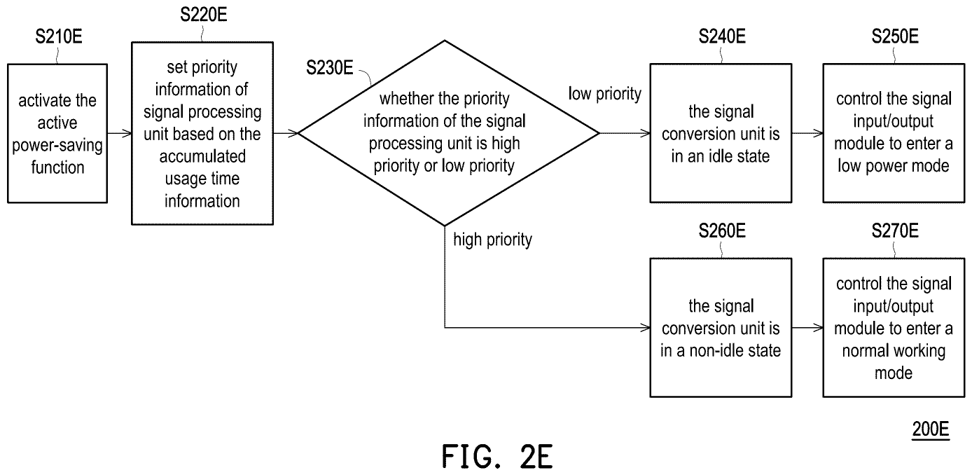

FIG. 2A to FIG. 2E are operation flow charts of the signal management system of this disclosure.

Please refer to FIG. 1A to FIG. 1C and FIG. 2A. An operation flow 200A of the signal management systems 100A to 100C mainly includes steps S210A to S230A.

In step S210A, the control unit 120 is configured to determine whether the signal conversion unit 116 of the signal input/output module 110 is in an idle state. If so, then proceed to step S220A, where the control unit 120 is configured to control the signal input/output module 110 to enter a low power mode. If not, then proceed to step S230A, where the control unit 120 is configured to control the signal input/output module 110 to enter a normal working mode.

The following further explains the specific implementation of the operation flow 200A of the signal management systems 100A to 100C.

Please refer to FIG. 1A to FIG. 1C and FIG. 2B. In the first embodiment, an operation flow 200B includes steps S210B to S260B. In step S210B, the active power-saving function of the signal input/output module 110 is activated. Specifically, for example, the control unit 120 receives a power-saving function activating instruction from the user interface 200, thereby activating the active power-saving function and executing subsequent steps accordingly. In step S220B, the control unit 120 is configured to receive a status indication signal from the connection port 112, and determine whether the connection port 112 is in a connected state or an unconnected state based on the status indication signal. In response to the control unit 120 determining that the connection port 112 is in an unconnected state in step S220B, proceed to step S230B, where the control unit 120 determines that the signal conversion unit 116 is in an idle state, and then proceed to step S240B, where the control unit 120 is configured to control the signal input/output module 110 to enter a low power mode. In response to the control unit 120 determining that the connection port 110 is in a connected state in step S220B, proceed to step S250B, where the control unit 120 determines that the signal conversion unit 116 is in a non-idle state, and then proceed to step S260B, where the control unit 120 is configured to control the signal input/output module 110 to enter a normal working mode.

The status indication signal of the connection port 112 is configured to indicate whether the connection port 112 is in a connected state (i.e., the connection port 112 is occupied) or an unconnected state (i.e., the connection port 112 is not occupied). For example, in some embodiments, the connection port 112 (e.g., HDMI, DP, HDBaseT) includes a Hot Plug Detection (HPD) pin. Moreover, the Hot Plug Detection pin is used to receive a Hot Plug Detection voltage from a corresponding pin of an external device as a status indication signal. For example, when the connection port 112 is connected to an external device, the external device provides a first voltage (e.g., a logic high voltage) to the Hot Plug Detection pin as the Hot Plug Detection voltage, and the status indication signal of the Hot Plug Detection pin indicates that the connection port 112 is in a connected state. On the other hand, when the connection port 112 is not connected to an external device, the Hot Plug Detection pin has a second voltage (e.g., a logic low voltage), and the status indication signal of the Hot Plug Detection pin indicates that the connection port 112 is in an unconnected state. However, this disclosure is not limited to this.

As an extension of this embodiment, when the signal input/output module 110 is already in the low power mode, in response to the status indication signal of the connection port 112 of the signal input/output module 110 indicating that the connection port 112 is in a connected state, the control unit 120 controls the signal input/output module 110 to switch from the low power mode to the normal working mode. In other words, the control unit 120 automatically controls each signal input/output module 110 to switch between the low power mode and the normal working mode based on the change in the connection state indicated by the status indication signal of the connection port 112 of the signal input/output module 110, thereby avoiding energy waste caused by idle operation of the signal conversion unit 116 of the connection port 112 that is not connected to an external device.

It should be noted that in most embodiments, especially in embodiments where the connection port 112 is not configured to provide a connection status indication signal, the control unit 120 may receive a wake-up instruction from the user interface 200. The wake-up instruction is used to indicate that the signal input/output module 110 should switch from the low power mode to the normal working mode. Moreover, the control unit 120 controls the signal input/output module 110 to switch from the low power mode to the normal working mode according to the wake-up instruction.

Next, please refer to FIG. 1A to FIG. 1C and FIG. 2C. In the second embodiment, the operation process 200C of the signal management system includes steps S210C to S260C.

In step S210C, similar to step S210B, the active power-saving function of the signal input/output module 110 may be activated, and the relevant details may be referred to in the description of step S210B, which will not be repeated here.

In step S220C, the control unit 120 determines whether the signal conversion unit 116 is in an idle state based on the working status information returned by the signal conversion unit 116. If yes, proceed to step S230C. The signal conversion unit 116 is determined to be in an idle state, and proceed to step S240C, in response to the signal conversion unit 116 being determined to be in an idle state, the control unit 120 is configured to control the signal input/output module 110 to enter the low power mode; if no, then proceed to step S250C, determine that the signal conversion unit 116 is in a non-idle state, and proceed to step S260C, the control unit 120 is configured to control the signal input/output module 110 to enter the normal working mode.

In this embodiment, the control unit 120 is electrically connected to the signal conversion unit 116 to receive the working status information of the signal conversion unit 116. Specifically, the signal conversion unit 116, for example, provides working status information to the control unit 120 via the Inter-Integrated Circuit (I2C) communication protocol or Serial Peripheral Interface (SPI) communication protocol. For example, the working status information indicates that the signal conversion unit 116 is in a working state (e.g., performing signal format conversion) or a non-working state (e.g., not performing signal format conversion).

In this way, the control unit 120 may automatically adjust the signal input/output module 110 to the normal working mode or the low power mode based on the working status of the signal conversion unit 116, thereby improving the energy utilization efficiency of the signal input/output module 110.

Next, please refer to FIG. 1A to FIG. 1C and FIG. 2D. In the third embodiment, an operation process 200D of the signal management system includes steps S210D to S260D.

In step S210D, through the user interface 200, the control unit 120 may receive operation status setting information corresponding to the signal conversion unit 116. Then, in step S220D, the control unit 120 may determine whether the operation status setting information indicates that the signal conversion unit 116 is a predetermined idle unit or a predetermined working unit. If the signal conversion unit 116 is a predetermined idle unit, proceed to step S230D, determine that the signal conversion unit 116 is in an idle state, and enter step S240D, where the control unit 120 is configured to control the signal input/output module 110 to enter the low power mode; if the signal conversion unit 116 is a predetermined working unit, proceed to step S250D, determine that the signal conversion unit 116 is in a non-idle state, and enter step S260D, where the control unit 120 is configured to control the signal input/output module 110 to enter the normal working mode.

In this embodiment, the control unit 120 is used to receive operation status setting information from the user interface 200. The operation status setting information is configured to indicate whether the signal conversion unit 116 is a predetermined idle unit or a predetermined working unit. In other words, the user may establish operation status setting information corresponding to the signal conversion unit 116 associated with each connection port 112 in the control signal input/output module 110 via the user interface 200, thereby determining whether the signal conversion unit 116 is preset to the low power mode or the normal working mode.

In this way, the control unit 120 may automatically adjust the signal input/output module 110 to operate in the normal working mode or the low power mode according to the user's usage habits or requirements, thereby improving the user experience of the projector with the signal input/output module 110.

Next, please refer to FIG. 1C and FIG. 2E. In the fourth embodiment, an operation process 200E of the signal management system includes steps S210E to S270E.

In step S210E, similar to steps S210B and S210C, the active power-saving function of the signal input/output module 110 may be activated, and the relevant details can be referred to in the description of step S210B, which will not be elaborated in the following.

After activating the active power-saving function, in step S220E, the control unit 120 is configured to set priority information corresponding to each signal conversion unit 116 in multiple signal input/output modules 110 based on the accumulated usage time information corresponding to each of the multiple signal input/output modules 110. In step S230E, the control unit 120 determines whether the priority information of the signal conversion unit 116 for each of the multiple signal input/output modules 110 is set to high priority or low priority. When the priority information of the signal conversion unit 116 of one of the multiple signal input/output modules 110 is set to low priority, proceed to step S240E, where the control unit 116 determines that the signal conversion unit 116 of the one of the multiple particular signal input/output modules 110 is in an idle state, and then enter step S250E to control the one of the multiple signal input/output modules 110 to enter the low power mode. When the priority information of the signal conversion unit 116 of one of the multiple signal input/output modules 110 is set to high priority, proceed to step S260E, where the control unit 116 determines that the signal conversion unit 116 of the one of the multiple particular signal input/output modules 110 is in a non-idle state, and then enter step S270E to control the one of the multiple signal input/output modules 110 to enter the normal working mode.

In this embodiment, as shown in FIG. 1C, there are multiple signal input/output modules 110, and the control unit 120 may record the accumulated usage time of the connection port 112 for each signal input/output module 110. The calculation of the accumulated usage time is, for example, based on the accumulation of time when the connection port 112 is connected to an external device and the signal conversion unit 116 performs format conversion on the original input signal sig_in obtained from the external device to generate the target format signal sig_ta, thereby producing a priority order among the multiple signal input/output modules 110. Specifically, the control unit 120 ranks the accumulated usage time information of the connection port 112 for each of the multiple signal input/output modules 110. Then, the control unit 120 obtains a first group of signal input/output modules from the multiple signal input/output modules 110 that is/are within a preset ranking, and a second group of signal input/output modules from the multiple signal input/output modules 110 that is/are outside the preset ranking. Subsequently, the control unit 120 sets the priority information of the signal conversion unit 116 for each of the first group of signal input/output modules in the multiple signal input/output modules 110 to high priority, and sets the priority information of the signal conversion unit 116 for each of the second group of signal input/output modules in the multiple signal input/output modules 110 to low priority.

In this way, the control unit 120 assigns high priority to the signal conversion unit 116 corresponding to the connection port 112 that is more frequently used by the user, and assigns low priority to the signal conversion unit 116 corresponding to the connection port 112 that is relatively less used. Since the signal conversion unit 116 with low priority is preset to operate in low power mode, this reduces electrical energy waste based on the user's usage habits.

In addition, the signal input/output module 110 may also possess special function setting information. The special function setting information is used to indicate whether this signal input/output module 110 is used for a special function. The control unit 120 sets the priority information of the signal conversion processing unit 116 for each of the multiple signal input/output modules 110 according to the special function setting information of each of the multiple signal input/output modules 110. For example, when the special function setting information corresponding to one of the signal input/output modules 110 is set to an activating state, the control unit 120 resets the priority information of the signal conversion unit 116 of the one of the signal input/output modules 110 to high priority.

For example, the special function may be a Picture-In-Picture (PIP) function or a 3D cascading function. When the special function setting information of one of the signal input/output modules 110 includes the Picture-In-Picture function, and the Picture-In-Picture function of the projector is activated, regardless of whether the priority of this signal input/output module 110 is set to high or low based on the ranking of its connection port 112's accumulated usage time information, the priority information of this signal input/output module 110 will be overwritten to high priority. This causes that the signal conversion unit 116 of the corresponding signal input/output module 110 enters a normal working status.

The control unit 120 may store the accumulated time information of the connection port 112 and the priority information of the signal conversion unit 116 for each of the multiple signal input/output modules 110 in the storage unit 122, to serve as the basis for determination and operation in this embodiment.

In other embodiments, in response to the status indication signal of the connection port 112 of one of the signal input/output modules 110 indicating that the connection port 112 is in a connected state, the control unit 120 controls the one of the signal input/output modules 110 to switch from low power mode to normal working mode. In other words, the control unit 120 automatically controls the switching of each signal input/output module 110 between low power mode and normal working mode according to the change in connection status indicated by the status indication signal of the connection port 112 of the signal input/output module 110.

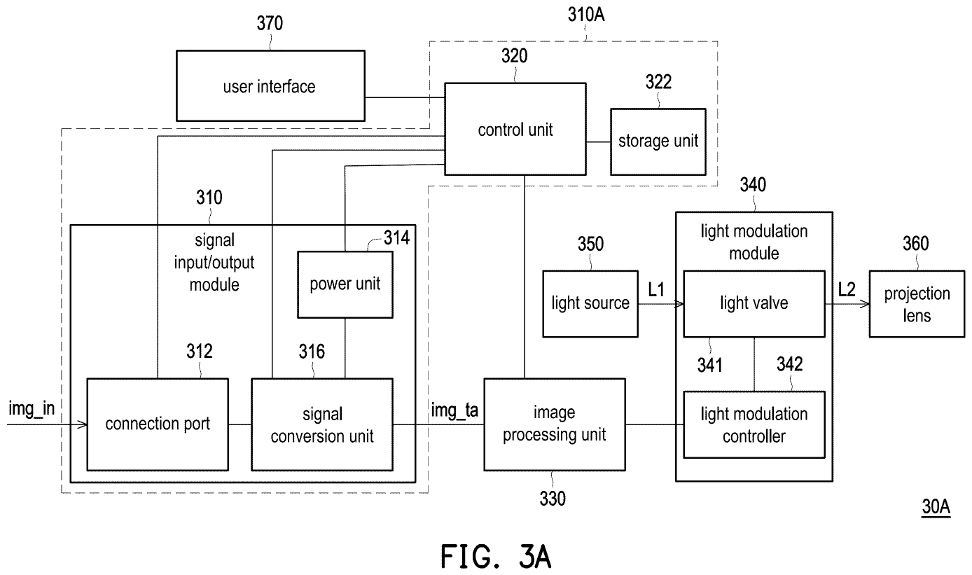

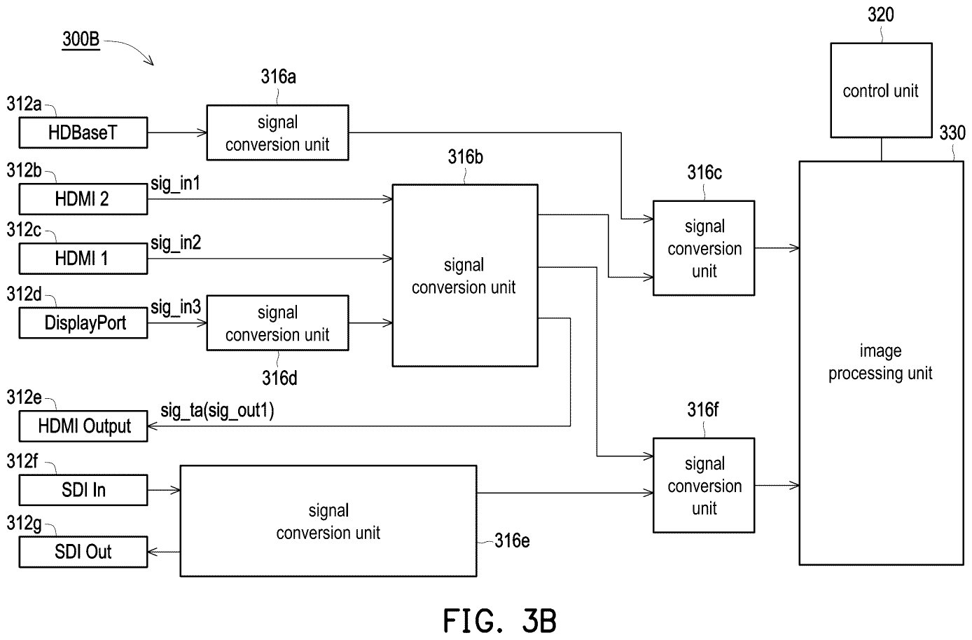

FIG. 3A is a block diagram of a projector of this disclosure. FIG. 3A illustrates an example of the overall hardware architecture of a projector 30A possessing a signal input/output module 310.

Please refer to FIG. 3A. The signal management system of this disclosure may be applied to a projector 30A, for example. The projector 30A includes a signal management system 310A, an image processing unit 330, a light modulation module 340, a light source 350, and a projection lens 360. The signal management system 310A includes a signal input/output module 310, a control unit 320, and a storage unit 322, and the signal input/output module 310 includes a connection port 312, a power unit 314, and a signal conversion unit 316. The connection and operation methods of the signal input/output module 310, the control unit 320, and the storage unit 322 in the signal management system 310A, as well as the connection port 312, the power unit 314, and the signal conversion unit 316, are similar to those described in other paragraphs of this specification for the signal input/output module 110, the control unit 120, the storage unit 122, the connection port 112, the power unit 114, and the signal conversion unit 16 of the signal management systems 100A to 100C, and possess similar or identical application effects, and therefore will not be repeated in the following.

In this embodiment, the original input signal sig_in received by the connection port 312 is an image signal. Connection ports 312 conforming to different standards are used to receive original input signals sig_in of different standards, and the corresponding signal conversion unit 316 is used to convert the original input signal sig_in into a target format signal sig_ta, which is one of the image signal formats acceptable by the image processing unit 330. The image processing unit 330 is electrically connected to the signal conversion unit 316 to receive the target format signal sig_ta. Moreover, the image processing unit 330 is configured to perform image processing (for example, scaling, cropping, deformation, etc.) on the target format signal sig_ta, to provide the processed target format signal sig_ta to a light modulation controller 342 of the light modulation module 340. In some embodiments, the image processing unit 330 may also be integrated within the signal management system 310A or within the signal input/output module 310, which is not limited by this disclosure.

The light source 350 is configured to provide an illumination beam L1. The light modulation module 340 is disposed on the transmission path of the illumination beam L1 and is configured to convert the illumination beam L1 into an image beam L2. Specifically, the light modulation module 340 includes a light valve 341 and a light modulation controller 342. The light modulation controller 342 is electrically connected to the image processing unit 330 and the light valve 341, and the light modulation controller 342 is configured to control the operation of the light valve 341 based on the processed target format signal sig_ta provided by the image processing unit 330, causing the light valve 341 to convert the illumination beam L1 into the image beam L2. Additionally, the projection lens 360 is disposed on the transmission path of the image beam L2, used to project the image beam L2 outside the projector 30A.

It should be noted that, for the sake of brevity, only one signal input/output module 310 is illustrated in FIG. 3A. However, as shown in FIG. 1C, there may be multiple signal input/output modules 310. Moreover, the electrical connection relationship between the signal input/output module 310 and the control unit 320 may be varied according to the electrical connection relationships shown in FIG. 1A to FIG. 1C, and this disclosure is not limited to this.

It is worth noting that, in some embodiments, the control unit 320 may be the main microcontroller unit (MCU) of the projector 30A. That is, the signal management system 310A directly uses the main MCU of the projector 30A as the control unit 320. In other embodiments, the control unit 320 may be another computing unit independent of the main MCU of the projector 30A (not shown in the figure). In other words, the control unit 320 is a processor specifically used for the signal management system 310A.

The projector 30A may further include a user interface 370. The user interface 370 is coupled to the control unit 320 and may be configured to receive operation status setting information, wake-up instructions, and power-saving function activation instructions, etc., and provide the operation status setting information, wake-up instructions, and power-saving function activation instructions to the control unit 320. In some embodiments, the user interface 370 may include an On Screen Display, a remote controller, a button module, other components with input functions, or a combination of these components. However, this disclosure is not limited to this.

It is worth noting that, in some embodiments, multiple signal input/output modules 310 may include a first signal input/output module and a second signal input/output module. Moreover, the control unit 320, in response to the signal conversion unit 316 of the first signal input/output module not being in an idle state, controls the second signal input/output module to enter a low power mode.

In other words, when the number of signal input/output modules 310 is multiple, and one of the signal input/output modules 310 is in a non-idle state, it represents that the projector 30A is currently using the external device connected to the connection port 312 of this signal input/output module 310 as the source of the original input signal, and generating the target format signal sig_ta through the image format conversion by the signal conversion unit 316 of this signal input/output module 310. In this case, other signal input/output modules 310 may not be used and may be in an idle state. Therefore, the control unit 320 may reduce the power consumption of other signal input/output modules 310, thereby reducing the overall power consumption of the projector 30A.

Please refer to FIG. 3B. FIG. 3B illustrates a block diagram of a signal management system 300B and an image processing unit 330. The signal management system 300B in FIG. 3B is an example of a partial circuit architecture illustrating the relationship between the connection port 312, the signal conversion unit 316, the control unit 320, and the image processing unit 330. Here, the power unit of the signal input/output module in the signal management system 300B and its corresponding connection relationships are omitted. The detailed architecture and electrical connection relationships between components can be referred to in the previous descriptions and will not be elaborated further in the following.

In one embodiment, the signal management system 300B may include multiple connection ports 312a to 312g and multiple signal conversion units 316a to 316f. For example, the connection ports 312a to 312g are sequentially connection terminals conforming to HDBaseT, HDMI, HDMI, DisplayPort, HDMI (Output), SDI In, and SDI Out transmission interface specifications. Each of the multiple connection ports 312a to 312g may be electrically connected to one of the multiple signal conversion units 316a to 316f. For instance, as shown in FIG. 3B, the connection port 312a is electrically connected to the signal conversion unit 316a. Alternatively, two or more of the multiple connection ports may be connected to the same signal conversion unit. For example, the connection ports 312b and 312c are both HDMI transmission interfaces, so they can be electrically connected to the same signal conversion unit 316b. However, this disclosure is not limited to this.

Additionally, the connection ports may also be connected to the image processing unit through multiple signal conversion units. For example, two stages of the signal conversion unit 316a and signal conversion unit 316c are disposed between the connection port 312a with HDBaseT transmission interface and the image processing unit 330. Alternatively, three stages of the signal conversion units 316d, 316b, and 316c are disposed between the connection port 312d with DisplayPort transmission interface and the image processing unit 330. In this case, the original input signal is first converted through the signal conversion unit 316d into a signal format that can be received by the signal conversion unit 316b before being transmitted to the signal conversion unit 316b.

Other possible application embodiments of the target format signal sig_ta are further explained below. For example, the signal conversion unit 316b may receive an original input signal sig_in1, sig_in2, or sig_in3 from one of the connection ports 312b, 312c, or 312d, perform format conversion on the original input signal sig_in1, sig_in2, or sig_in3 to generate a converted output signal sig_out1, and output the converted output signal sig_out1 to the connection port 312e. The connection ports 312b, 312c, or 312d may, for example, be connected to a first device (signal source device, such as a computer), while the connection port 312e may, for example, be connected to a second device (display device, such as an LCD screen). At this time, the target format signal sig_ta generated by the signal conversion unit 316b is the converted output signal sig_out1, and the signal conversion unit 316b is also determined by the control unit 320 to be in a non-idle state.

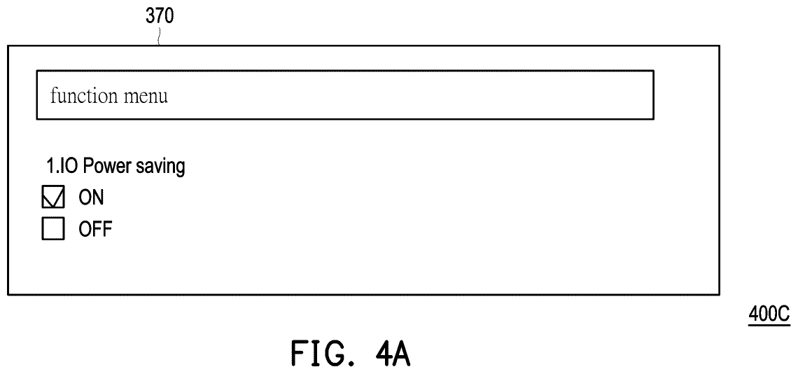

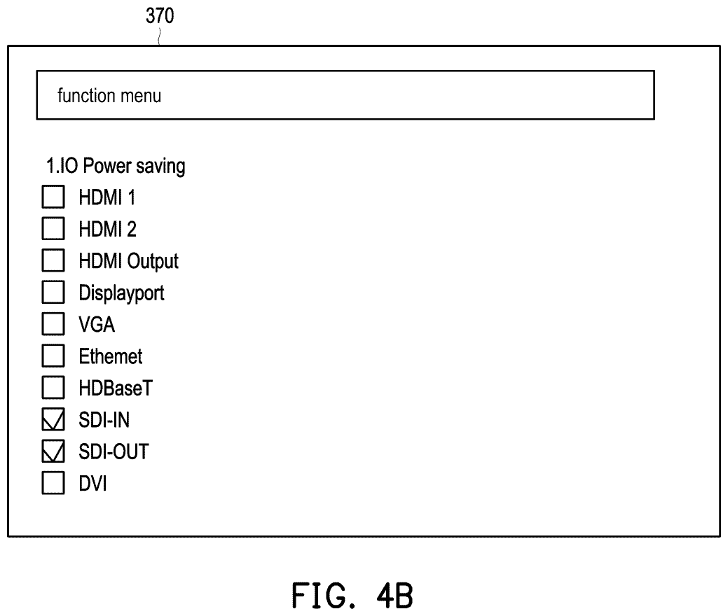

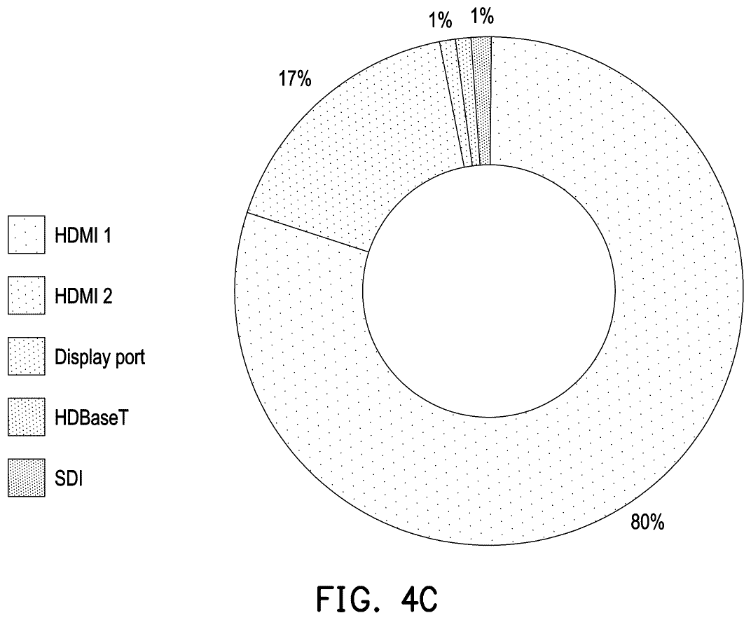

FIG. 4A to FIG. 4C are schematic diagrams of application states of a signal management system according to multiple embodiments of this disclosure.

Please refer to FIG. 4A. FIG. 4A illustrates a menu screen of an active Power Saving function presented by a user interface 370 (for example: On Screen Display). In another embodiment, the menu screen of the active Power Saving function may also be presented through an input unit (such as an LCD Panel). When the user checks the On option checkbox through the user interface 370, the user interface 370 receives an instruction to activate the power-saving function, thereby proceeding to execute subsequent steps, such as steps S210B, S210C, or S210E in the aforementioned first, second, and fourth embodiments.

Please refer to FIG. 3B and FIG. 4B together. FIG. 4B illustrates a menu image of a power-saving operation status setting function presented in the user interface 370. Specifically, the menu image of the power-saving operation status setting function lists the names and corresponding checkboxes of multiple different connection ports 312 (for example, including HDMI 1, HDMI 2, HDMI Output, DisplayPort, VGA, Ethernet, HDBaseT, SDI-IN, SDI-OUT). When the user checks the checkbox corresponding to at least one connection port 312 (for example, SDI-IN and SDI-OUT) through the input unit in the user interface 370, it indicates that the operation status setting information for the signal conversion unit 316 corresponding to the connection port 312 is set as a preset idle unit. The user interface 370 generates operation status setting information indicating that the signal conversion unit 316 corresponding to the checked connection port 312 is a preset idle unit, and transmits it to the control unit 316. At the same time, the user interface 370 may also generate operation status setting information indicating that the signal conversion unit 316 corresponding to the unchecked connection port 312 is a preset working unit, and transmit the operation status setting information to the control unit 316.

Please refer to FIG. 2E and FIG. 4C together. FIG. 4C illustrates a schematic diagram of the proportion of accumulated usage time compared to total usage time for different connection ports 312. Accordingly, the control unit 320 may generate priority information for each signal conversion unit 316 based on the accumulated usage time. For detailed operation methods, please refer to the explanation of the fourth embodiment mentioned earlier, which will not be repeated in the following.

In summary, the signal management system and projector of the embodiments of this disclosure possess at least one of the following advantages: they may automatically or passively reduce the power consumption of the signal conversion unit or stop providing power to the signal conversion unit based on the actual usage or usage requirements of the signal conversion unit. As a result, the signal management system and the projector with the signal management system can effectively save power without affecting usage, better utilize energy, and avoid electrical energy waste.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “this disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A signal management system, comprising at least one signal input/output module and a control unit, wherein:
the at least one signal input/output module is electrically connected to the control unit, and is configured to be controlled by the control unit to be operated in one of a normal working mode and a low power mode; the at least one signal input/output module comprises a connection port, a power unit, and a signal conversion unit, wherein
the connection port is configured to receive an original input signal;
the signal conversion unit is electrically connected to the connection port, and is configured to receive the original input signal from the connection port; and
the power unit is electrically connected to the signal conversion unit, and is configured to provide electrical energy to the signal conversion unit; wherein,
when the at least one signal input/output module is operated in the normal working mode, the connection port is configured to receive the original input signal, and the power unit provides the electrical energy to the signal conversion unit to enable the signal conversion unit to perform format conversion on the original input signal from the connection port to generate a target format signal; and
when the control unit determines that the signal conversion unit is in an idle state, the control unit controls the at least one signal input/output module to operate the at least one signal input/output module in the low power mode; wherein, the signal conversion unit in the low power mode has a first power consumption value correspondingly, the signal conversion unit in the normal working mode has a second power consumption value correspondingly, wherein the first power consumption value is lower than the second power consumption value.

2. The signal management system according to claim 1, wherein
the control unit is electrically connected to the signal conversion unit, the control unit controls the at least one signal input/output module to be operated in the low power mode by transmitting a power-saving instruction to make the signal conversion unit enter a power-saving state; wherein,
when the signal conversion unit enters the power-saving state, the power consumption of a preset circuit block of the signal conversion unit is reduced or the preset circuit block is turned off.

3. The signal management system according to claim 1, wherein
the control unit is electrically connected to the power unit, the control unit controls the power unit not to provide the electrical energy to the at least one signal input/output module, enabling the at least one signal input/output module to be operated in the low power mode.

4. The signal management system according to claim 1, wherein
the control unit is electrically connected to the connection port, and is configured to receive a status indication signal from the connection port; and
in response to the status indication signal indicating that the connection port is in an unconnected state, determining the signal conversion unit is in the idle state.

5. The signal management system according to claim 4, wherein
the status indication signal is configured to indicate that the connection port is in a connected state or the unconnected state; in response to the status indication signal indicating that the connection port is in the connected state, the control unit determines that the signal conversion unit is in a non-idle state, and controls the at least one signal input/output module to be operated in the normal working mode.

6. The signal management system according to claim 5, wherein
the connection port comprises a Hot Plug Detection (HPD) pin, wherein the HPD pin is configured to provide a HPD voltage as the status indication signal to the control unit;
when the HPD voltage is at a first voltage, the status indication signal indicates that the connection port is in the connected state;
when the HPD voltage is at a second voltage, the status indication signal indicates that the connection port is in the unconnected state.

7. The signal management system according to claim 1, wherein
the control unit is electrically connected to the signal conversion unit to receive working status information of the signal conversion unit, and the control unit is configured to determine whether the signal conversion unit is in the idle state according to the working status information.

8. The signal management system according to claim 7, wherein
the signal conversion unit is configured to:
provide the working status information to the control unit via an inter-integrated circuit communication protocol or a serial peripheral interface communication protocol.

9. The signal management system according to claim 1, wherein
the control unit is configured to receive operation status setting information from a user interface; wherein the operation status setting information is configured to indicate that the signal conversion unit is a preset idle unit or a preset working unit;
when the operation status setting information indicates that the signal conversion unit is the preset idle unit, the control unit determines that the signal conversion unit is in the idle state according to the operation status setting information.

10. The signal management system according to claim 1, wherein the at least one signal input/output module includes multiple signal input/output modules; the control unit is configured to:
respectively record a time of the connection port of each of the signal input/output modules in using status to generate accumulated usage time information corresponding to each of the signal input/output modules; wherein, when the signal conversion unit of one of the signal input/output modules conducts format conversion on the original input signal from the connection port of the one of the signal input/output modules to generate the target format signal, the connection port of the one of the signal input/output modules is determined to be in use status;
set priority information corresponding to the signal conversion unit of each of the signal input/output modules according to the accumulated usage time information corresponding to the each of the signal input/output modules; and
when the priority information of the signal conversion unit of the one of the signal input/output modules is set to low priority, the signal conversion unit of the one of the signal input/output modules is determined to be in the idle state.

11. The signal management system according to claim 10, wherein when the control unit sets the priority information of the signal conversion unit corresponding to the each of the signal input/output modules according to the accumulated usage time information of the each of the signal input/output modules, the control unit is configured to:
rank the accumulated usage time information of the connection port of the each of the signal input/output modules;
obtain a first group of signal input/output modules within a preset ranking from the signal input/output modules and a second group of signal input/output modules outside the preset ranking from the signal input/output modules; and
set the priority information of the signal conversion unit of each of the first group of signal input/output modules from the signal input/output modules to high priority, and set the priority information of the signal conversion unit of each of the second group of signal input/output modules from the signal input/output modules to the low priority.

12. The signal management system according to claim 10, wherein the control unit is configured to:
set the priority information of the signal conversion unit of the each of the signal input/output modules according to special function setting information of the each of the signal input/output modules.

13. The signal management system according to claim 10, wherein the signal management system comprises:
a storage unit, electrically connected to the control unit; wherein,
the control unit stores the accumulated time information of the connection port of each of the signal input/output modules and the priority information of the signal conversion unit to the storage unit.

14. The signal management system according to claim 1, wherein,
the at least one signal input/output module comprises multiple signal input/output module, and the signal input/output modules comprise a first signal input/output module and a second signal input/output module;
in response to the signal conversion unit of the first signal input/output module not being in the idle state, the control unit is configured to control the second signal input/output module to enter the low power mode.

15. The signal management system according to claim 1, wherein,
the connection port comprises a High-Definition Multimedia Interface (HDMI) input port, a High-Definition Multimedia Interface (HDMI) output port, a DisplayPort, a Serial Digital Interface (SDI) input port, a Serial Digital Interface (SDI) output port, or a High-Definition Base-T (HDBaseT) port.

16. The signal management system according to claim 1, wherein,
the control unit is configured to receive a wake-up instruction from a user interface, and the control unit is configured to control the signal input/output module to switch from the low power mode to the normal working mode according to the wake-up instruction.

17. The signal management system according to claim 1, wherein,
in response to a status indication signal indicating that the connection port is in a connected state, the control unit is configured to control the at least one signal input/output module to switch from the low power mode to the normal working mode.

18. The signal management system according to claim 1, wherein the signal management system further comprises:
an image processing unit, electrically connected to the signal conversion unit to receive the target format signal, wherein the image processing unit is configured to perform image processing on the target format signal to provide a processed target format signal.

19. A projector, comprising a signal management system, an image processing unit, a light source module, a light modulation module, and a projection lens, wherein:
the signal management system comprises at least one signal input/output module and a control unit, wherein:
the at least one signal input/output module is electrically connected to the control unit, and is configured to be controlled by the control unit to be operated in one of a normal working mode and a low power mode, the at least one signal input/output module comprises a connection port, a power unit, and a signal conversion unit, wherein
the connection port is configured to receive an original input signal;
the signal conversion unit is electrically connected to the connection port, and is configured to receive the original input signal from the connection port; and
the power unit is electrically connected to the signal conversion unit, and is configured to provide electrical energy to the signal conversion unit; wherein,
when the at least one signal input/output module is operated in the normal working mode, the connection port is configured to receive the original input signal, the power unit provides the electrical energy to the signal conversion unit to enable the signal conversion unit to perform format conversion on the original input signal from the connection port to generate a target format signal; and
when the control unit determines that the signal conversion unit is in an idle state, the control unit controls the at least one signal input/output module, making the at least one signal input/output module to be operated in the low power mode; wherein, the signal conversion unit in the low power mode has a first power consumption value correspondingly, the signal conversion unit in the normal working mode has a second power consumption value correspondingly, wherein the first power consumption value is less than the second power consumption value;
the image processing unit is electrically connected to the signal conversion unit to receive the target format signal, and the image processing unit is configured to perform image processing on the target format signal to provide a processed target format signal;
the light source module is configured to provide an illumination light beam;
the light modulation module is electrically connected to the image processing unit, disposed on a transmission path of the illumination light beam, and configured to convert the illumination light beam into an image light beam according to the processed target format signal provided by the image processing unit; and
the projection lens is disposed on a transmission path of the image light beam, and is configured to project the image light beam outside the projector.

20. The projector according to claim 19, wherein the projector further comprises:
a user interface, configured to:
receive operation status setting information, and provide the operation status setting information to the control unit, wherein the operation status setting information is configured to indicate that the signal conversion unit is a preset idle unit or a preset working unit; and
when the operation status information indicates that the signal conversion unit is a preset idle unit, the control unit is configured to determine that the signal conversion unit is in the idle state.
